(19) United States
(12) Patent Application Publication
(10) Pub. No.: US 2018/0115274 A1
(43) Pub. Date: Apr. 26, 2018

(54) TILE REPLACEMENT SOLAR MOUNTING SYSTEM

(71) Applicant: PEGASUS SOLAR INC., Richmond, CA (US)

(72) Inventors: Erich Kai Stephan, San Francisco, CA (US); Glenn Harris, Sausalito, CA (US); Peter Wilke, Laguna Niguel, CA (US)

(21) Appl. No.: 15/793,212

(22) Filed: Oct. 25, 2017

Related U.S. Application Data
(60) Provisional application No. 62/413,204, filed on Oct. 26, 2016.

(51) Int. Cl. H02S 20/23; E04D 13/14; E04D 1/18

(52) U.S. Cl. CPC H02S 20/23; F24J 2/5239; E04D 1/18; E04D 13/14

(57) ABSTRACT

A tile replacement mounting system includes a base flashing between an attachment bracket and an installation surface. The attachment bracket is attached to the installation surface with a fastener. A post is connected to the attachment bracket, and an extender arm is connected to the post. A mounting clamp assembly is connected to the extender arm and is used to connect to a solar panel.

### CROSS-REFERENCE TO RELATED APPLICATION

This application claims priority to U.S. Provisional Patent Application No. 62/413,204, filed on Oct. 26, 2016, the content of which is herein incorporated by reference.

### BACKGROUND

Solar energy panels are becoming increasingly popular. However, current solar panel mounting solutions are overly complicated, not reliable, and otherwise inadequate. For example, current solar panel mounting solutions involve complicated systems for coupling a mounting system to a tile roof.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a tile replacement mounting system;

FIG. 2A illustrates a base flashing for the tile replacement mounting system;

FIG. 2B illustrates a top view of a base flashing with a chevron-shaped ridge feature;

FIG. 2C illustrates a top view of a base flashing with a curved ridge feature;

FIG. 3A illustrates an attachment bracket for the tile replacement mounting system;

FIG. 3B illustrates an attachment bracket fastened to an installation surface over a base flashing;

FIG. 4A illustrates the tile replacement mounting system with a tile replacement flashing installed over the base flashing and the attachment bracket;

FIGS. 4B-4C illustrates a tile replacement flashing with stiffening ribs;

FIG. 5A illustrates the post for the tile replacement mounting system;

FIG. 5B illustrates the post coupled with the attachment bracket;

FIG. 5C illustrates a post with an internal threading section;

FIG. 5D illustrates a post with a portion of its body truncated;

FIGS. 6A-6B illustrate a tile replacement mounting system with a post installed through a tile replacement flashing into an attachment bracket;

FIG. 6C illustrates a tile replacement mounting system with a post having an internal threading section;

FIGS. 7A-7B illustrate an extender arm that is configured to couple with the threaded section of the post;

FIG. 8 illustrates an S-type tile replacement mounting system;

FIG. 9A illustrates a tile replacement mounting system with a post installed through an aperture of a tile replacement flashing;

FIG. 9B illustrates the tile replacement mounting system with a post and a vertical post extender;

FIGS. 10A-10F illustrate a tile replacement mounting system with an extender arm;

FIG. 11 illustrates a tile replacement mounting system with integrally-formed post, extender arm, and vertical extender component;

FIGS. 12A-12E illustrate an extender arm that is configured to couple with the post;

FIGS. 13A-13C illustrate a tile replacement mounting system with an extender arm connected to a post that is connected to an attachment bracket and fastened to an installation surface over a base flashing;

FIGS. 14A-14B illustrate an S-type tile replacement mounting system;

FIG. 15A-15D illustrate an extender arm that is configured to couple with the post;

FIG. 16A-16B illustrate a tile replacement mounting system with an extender arm connected to a post that is connected to an attachment bracket and fastened to an installation surface over a base flashing; and

FIG. 17 illustrates an S-type tile replacement mounting system.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

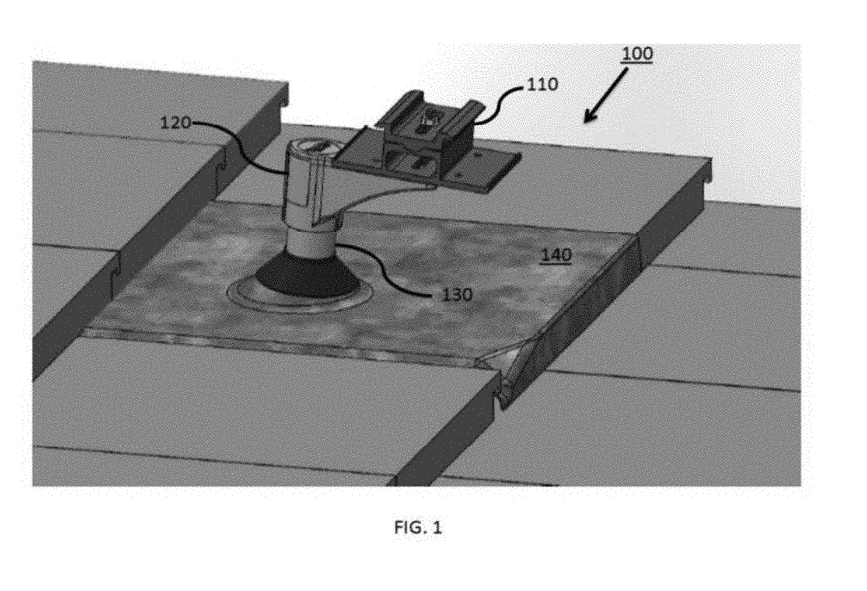

FIG. 1 illustrates a tile replacement mounting system 100 including a mounting clamp assembly 110 coupled to a support arm assembly 120 that is thread onto a post 130 secured to an installation surface through a tile replacement flashing 140. Some embodiments of the present technology involve a base flashing and an attachment bracket that can be used to secure the post 130 to the installation surface.

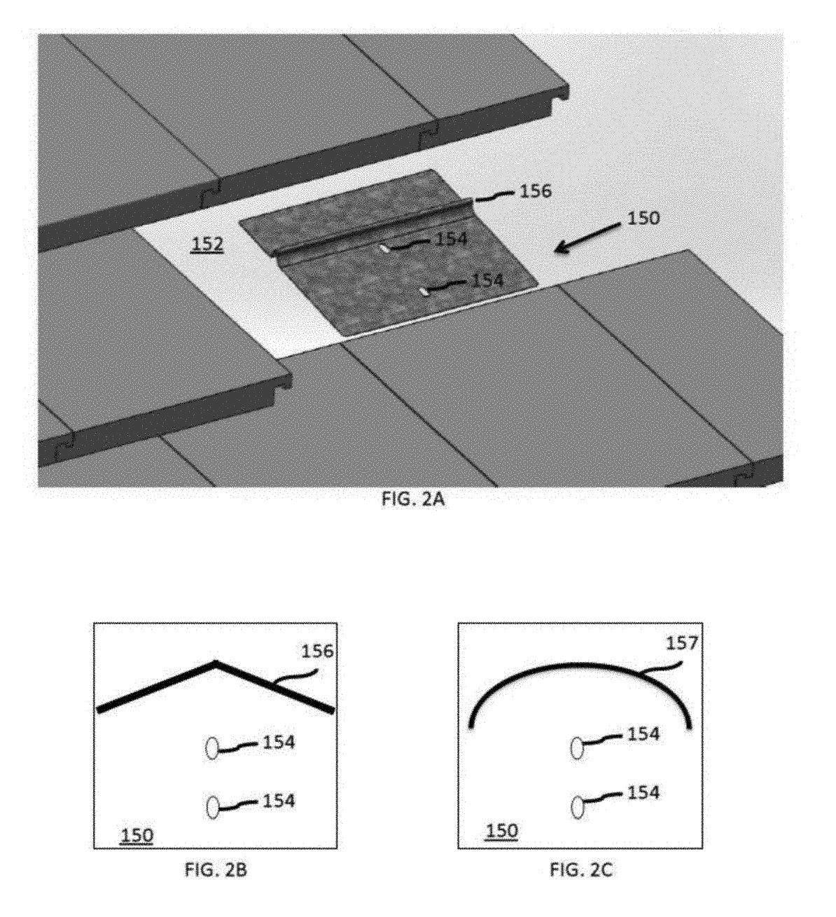

FIG. 2A illustrates a base flashing 150 that can be used in the tile replacement mounting system 100. The base flashing 150 can be installed on an installation surface 152 and can be configured to act as a barrier to water reaching holes in the installation surface 152 created through installing the tile replacement mounting system 100. In some cases, the installation surface 152 can be covered with a moisture barrier, vapor barrier, etc. and a portion of the base flashing 150 can slide under the barrier.

The base flashing 150 can include through-holes 154 for allowing fasteners to traverse the base flashing 150 and to be fastened to the installation surface. Also, the through-holes 154 can be sized to allow the base flashing a degree of movement about a fastener until the fastener is tightly secured to the installation surface 152.

The base flashing 150 can include a ridge feature 156 that extends across the base flashing 150. The ridge feature 156 can be used to inhibit water from flowing into the region of the base flashing 150 containing the through-holes 154. For example, when an installation surface is sloped, the base flashing 150 can be positioned with the ridge feature 156 up-slope from the through-holes 154. In this configuration, water flowing down-slope on the installation surface is inhibited by the ridge feature 156 and prevented from reaching the through-holes 154. In some cases, the surfaces of the ridge feature 156 are configured at angles that allow the base flashing 150 to stack on a like base flashing 150. Also, in some cases, the ridge feature 156 has a geometry that prevents water from pooling along its surface. For example, FIG. 2B illustrates a top view of a base flashing 150 with a chevron-shaped ridge feature 156 and FIG. 2C illustrates a top view of a base flashing 150 with a curved ridge feature 157.

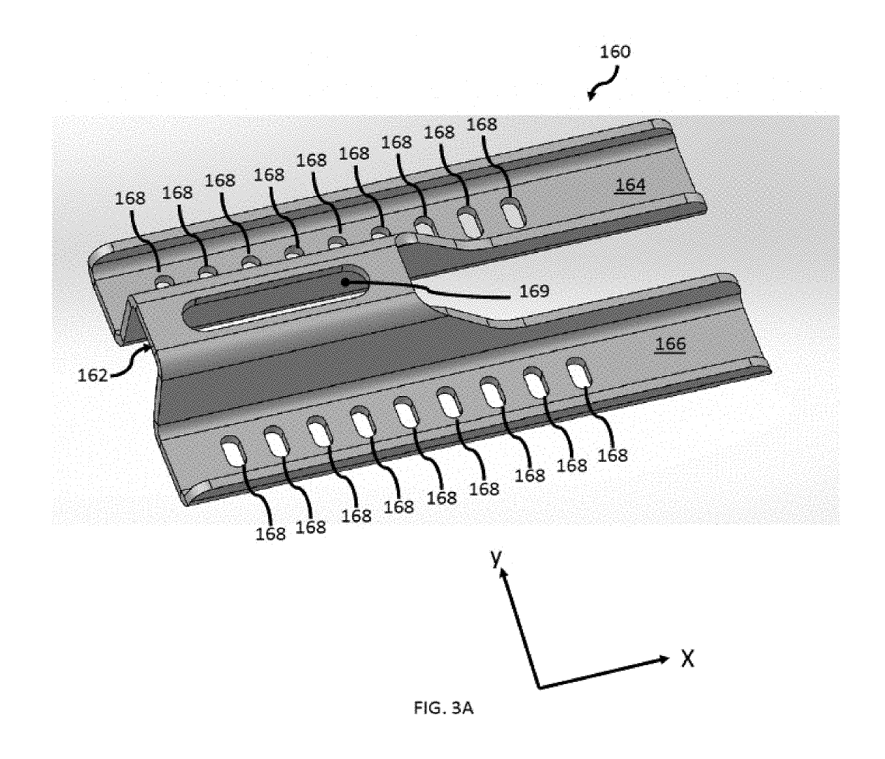

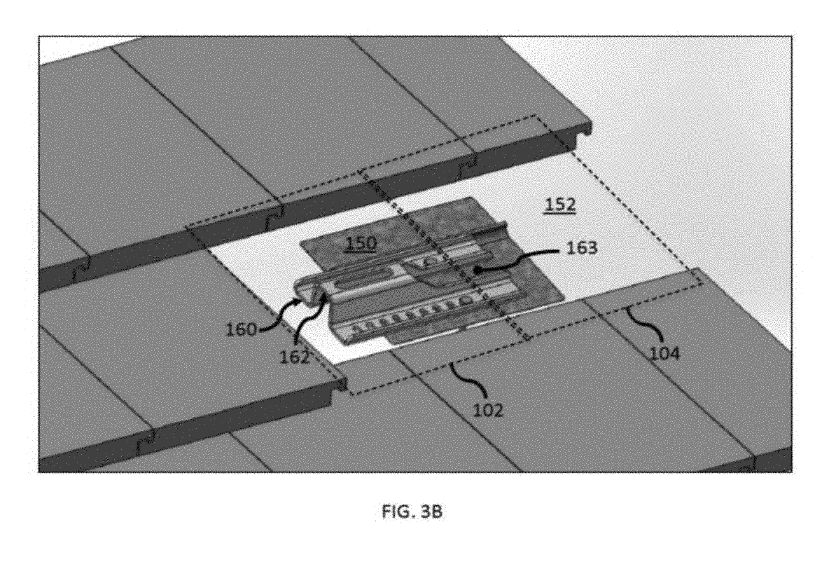

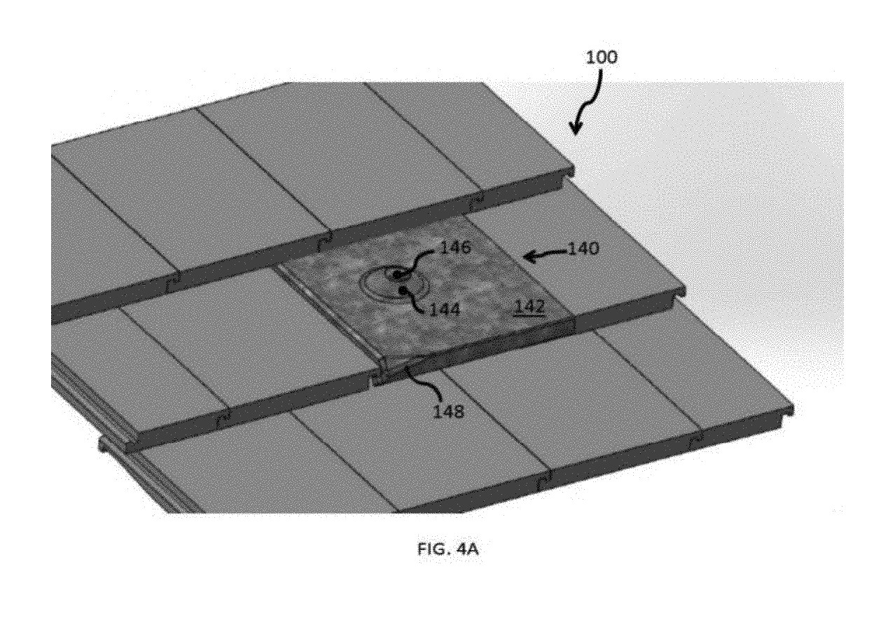

The tile replacement mounting system 100 can also include an attachment bracket that supports the post 130. FIG. 3A illustrates an attachment bracket 160. The attachment bracket 160 includes a raised center section 162 and two flat sections 164, 166 that interface with the base flashing 150 or directly with an installation surface. In some cases, the flat sections 164, 166 include a plurality of attachment slots 168 along the length of the attachment bracket 160. The attachment slots are configured to receive at least one fastener for coupling the attachment bracket 160 to the installation surface.

The attachment bracket 160 also includes a post slot 169 in the raised center section 162. The post slot 169 can be configured to accept a coupling feature of a post, e.g. a T-bolt, cam fastener, etc. (explained in greater detail below). The post slot 169 can have an extended length (i.e. along the x-axis) to allow the post to be coupled in a variety of positions within the post slot 169. Also, the multiple attachment slots 168 allow the attachment bracket 160 to be fastened in a variety of positions relative to a roof joist, stud, etc. Additionally, the raised center section 162 can be truncated to occupy only a portion of the length (i.e. along the x-axis) of the attachment bracket 160—leaving a gap 163 (See FIG. 3B) or a flat center portion (not shown). The gap 163 or flat center portion defined by the truncated raised center section 162 can accommodate the attachment bracket 160 being partially positioned under an adjacent tile.

The multiple attachment slots 168 can also extend along a width (i.e. the y-axis) of the flat sections 164, 166 to allow the attachment bracket 160 to be adjusted up and down on an installation surface. The attachment slots 168 can be sized to allow the attachment bracket 160 a degree of movement about one or more fasteners until the fastener(s) is tightly secured to the installation surface 152. Furthermore, the extended post slot 169 and the multiple attachment slots 168 allow the attachment bracket to be fastened to a roof joist, etc., in a variety of positions while the post 130 remains in the same position relative to the installation surface and tiles. Moreover, the adjustability provided by the extended post slot 169, the multiple attachment slots 168, the extended width of the attachment slots 168, and the truncated raised center section 162 provide synergistic adjustment effects in both the x-axis and y-axis directions. The extended post slot 169 may provide additional x-axis flexibility to position the post 130 after the attachment bracket 160 has already been secured to installation surface 152. In some cases, the attachment bracket 160 can be formed of a single piece of sheet metal. Also, the attachment bracket 160 can be formed without having any orthogonal features, thereby allowing multiple attachment brackets to be stackable with one another.

FIG. 3B illustrates an attachment bracket 160 fastened to an installation surface 152 over a base flashing 150. The installation surface 152 is exposed after removing two tiles 102, 104 (illustrated using dashed lines). As shown, the gap 163 or flat center portion defined by the truncated raised center section 162 allows the attachment bracket 160 to fit under tile 104. Therefore, installation of the attachment bracket 160 can be achieved by replacing only tile 102, and attachment bracket 160 can be fastened to a structural rafter under roof tile 104 without interference with roof tile 104. After the attachment bracket 160 is fastened to the installation surface 152, a tile replacement flashing 140 can be coupled with adjacent tiles, and may take the place of roof tile 102.

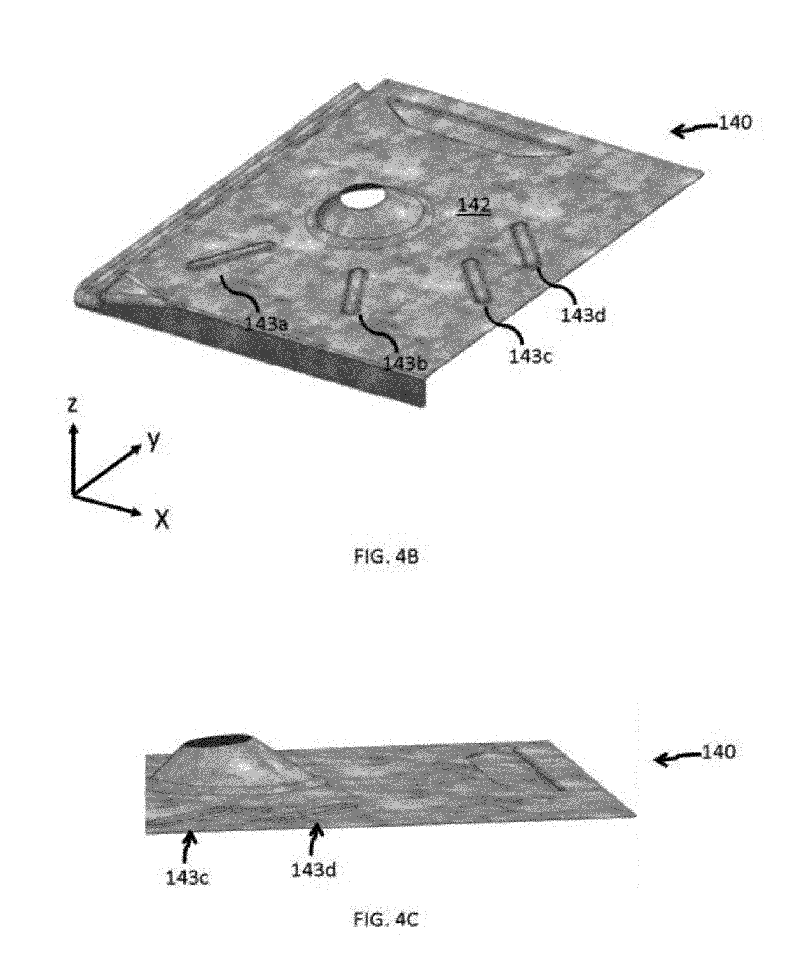

FIG. 4A illustrates the tile replacement mounting system 100 with a tile replacement flashing 140 installed over the base flashing 150 and the attachment bracket 160. In the some embodiments, the tile replacement flashing 140 includes a substantially planar surface 142 and a conical protrusion 144 having an aperture 146 disposed therethrough. The conical protrusion 144 prevents water running over the tile replacement flashing 140 from entering the aperture 146. The aperture 146 can be configured to receive the post 130. In some cases, the dimensions of the aperture 146 are slightly larger than the dimensions of the post 130 to facilitate installation of the post 130 through the aperture 146 and to allow the post 130 to couple with the attachment bracket 160 (as shown in more detail below).

The conical protrusion 144 can be configured with an angle of protrusion from the plane of the tile replacement flashing 140 that is selected for one or more design objective. For example, the conical protrusion 144 can be non-orthogonal to the plane of the tile replacement flashing 140. In these cases, the conical protrusion 144 is configured with angle of protrusion from the plane of the tile replacement flashing 140 that accounts for an angle of a roof such that the post is perpendicular to the installation surface 152 when installed within the tile replacement mounting system 100. The tile replacement flashing 140 can also include a chamfer 148 on a corner of the top surface to facilitate easier manufacturing of the tile replacement flashing 140. In the embodiment shown, the chamfer 148 reduces the drawing required of the metal on the corner of the tile replacement flashing 140 where it interlocks with adjacent roof tile and forms down to meet the roof tile below.

Some embodiments of the present invention involve a tile replacement flashing with upward and/or downward protruding stiffening ribs formed into its planar surface. FIG. 4B-4C illustrates a tile replacement flashing 140 with stiffening ribs 143a-143d formed into its planar surface 142. The stiffening ribs 143a-143d serve to ensure the planar surface 142 remains substantially planar during the manufacturing process. Stiffening ribs 143a-143d can also provide structural rigidity to help maintain a flat profile of tile replacement flashing 140 during its installation on a tile roof. Stiffening ribs 143a-143d may be angled relative to the x-axis in order to allow water to flow off tile replacement flashing 140 and not pool. Stiffening ribs 143a-143d that are protruding downward towards the installation surface may also have an angled protrusion profile relative to the Z-axis to allow water to drain out. Stiffening ribs 143a-143d may also have a protrusion profile with drafted sides to allow for stackability of multiple tile replacement flashings 140.

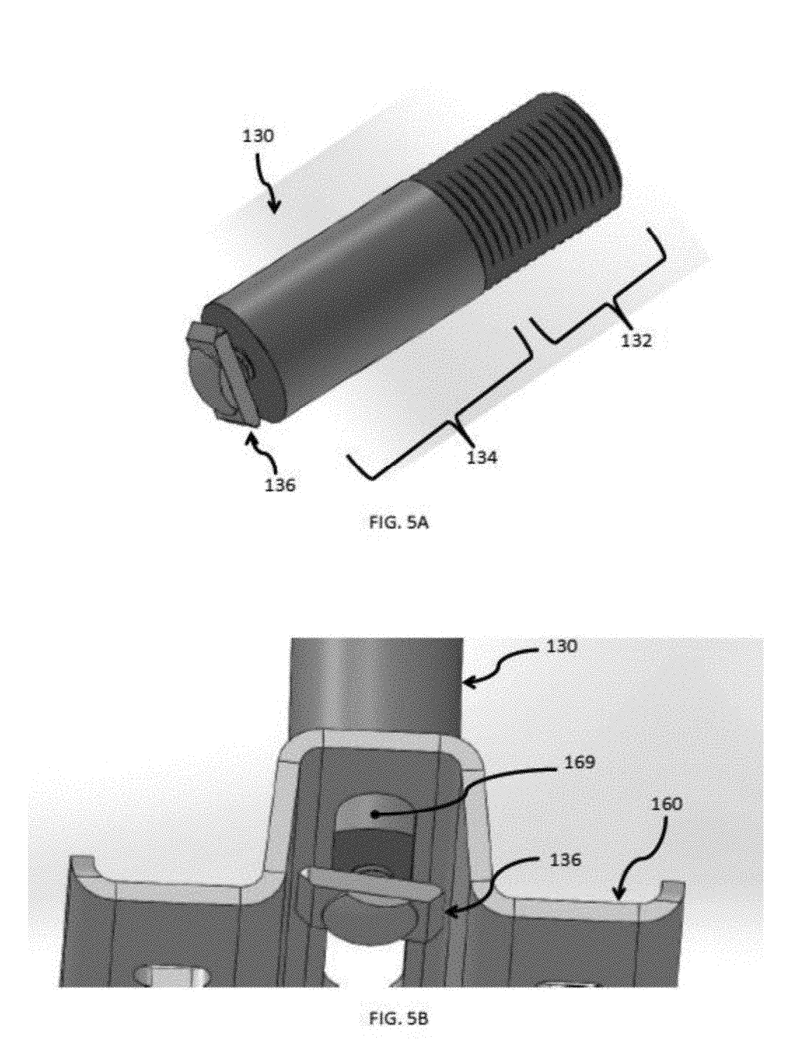

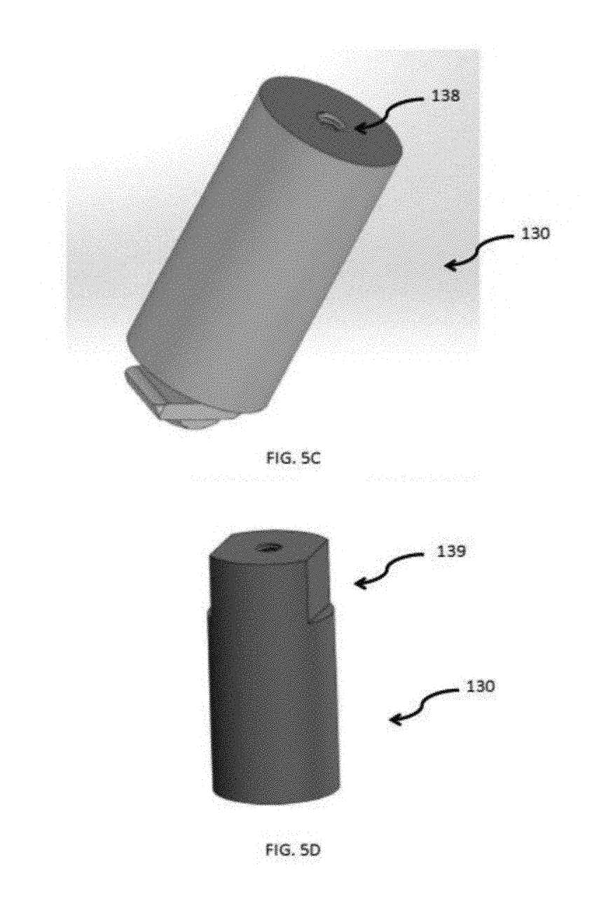

FIG. 5A illustrates the post 130 according to some embodiments of the present technology. The post 130 can be a substantially axial member with a threaded section 132 on a first terminal end, a non-threaded extender section 134, and a coupling mechanism 136 on a second terminal end. The threaded section 132 can be configured to thread into the internal threading of a support arm assembly 120 or extender arm (as explained below). The non-threaded extender section 134 can be configured to traverse the aperture 146 in the conical protrusion 144 of the tile replacement flashing 140 to allow the coupling mechanism 136 to couple with the attachment bracket 160. Also, the non-threaded extender section 134 extends away from the installation surface such that a component threaded onto the threaded section 132 can be adjusted to various heights relative to the installation surface without requiring adjustment to the post 130 or attachment bracket 160. The post 130 can also have an internal threaded section on a first terminal end to allow for attachment of other brackets. In this case, the post 130 may not have an external threaded section 132, as shown in FIG. 5C. Instead, the post 130 can have an internal threading section 138 to attach other components, such as an L-Foot.

Additionally, the post 130 can have a length to accommodate roofing tiles having a wide range of thicknesses and types (e.g. flat roofing tiles, S-type roofing tiles, ridge-type roofing tiles, Spanish-type roofing tiles, etc.). In some embodiments, post 130 may have all or a portion 139 of its body truncated to allow for a wrench to easily grip and rotate said post 130, as shown in FIG. 5D.

Also, the aperture 146 of the conical protrusion 144 of the tile replacement flashing 140 can be configured to allow the coupling mechanism 136 of the post 130 to be coupled with the attachment bracket 160 before or after the tile replacement flashing 140 is installed over the attachment bracket 160. This allows an installer to be able to install the tile replacement mounting system 100 without having to lift adjacent tiles when sliding in the tile replacement flashing 140.

In some cases, the attachment bracket 160 can be coupled with the post 130 and the tile replacement flashing 140 can be placed over the post 130 before fastening the attachment bracket 160 to the installation surface 152. The tile replacement flashing 140 can be removed to expose an area over the installation surface where the post can be located when the tile replacement flashing is finally installed. Next, the attachment bracket 160 can be adjusted (e.g. by selecting the appropriate attachment slots 168) to allow the post to be positioned within the appropriate area and to allow attachment slots 168 to align with a joist, stud, etc.

FIG. 5B illustrates the post 130 coupled with the attachment bracket 160 according to some embodiments of the present technology. In FIG. 5B the coupling mechanism 136 is a T-bolt coupling that fits into the post slot 169 of the attachment bracket 160. The T-bolt type coupling mechanism 136 is positioned through the post slot 169 and then post 130 can be twisted to engage the T-bolt type coupling mechanism 136 with the sides of the attachment bracket 160 to secure the post 130 within the attachment bracket 160. The T-bolt type coupling mechanism interferes with the sides of the attachment bracket 160 when the post 130 is rotated, thereby engaging the threads of the T-bolt type coupling mechanism to compress the post 130 against the attachment bracket 130. In some cases, the coupling mechanism 136 is a cam type mechanism. In these cases, the cam type coupling mechanism 136 of the post 130 can be installed in the post slot 169 and turned (e.g. ninety degrees) to engage with the side walls of the attachment bracket and an internal mechanism in the post would draw the post 130 against the attachment bracket 160. In either case, the post 130 can be pre-assembled with the t-bolt type coupling mechanism 136 or cam type mechanism to allow for reduced installation time on the rooftop.

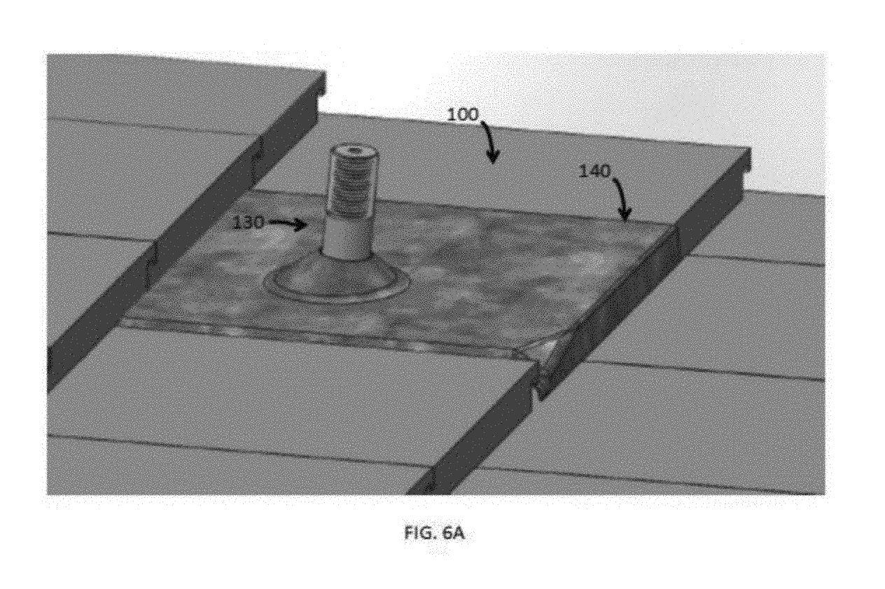

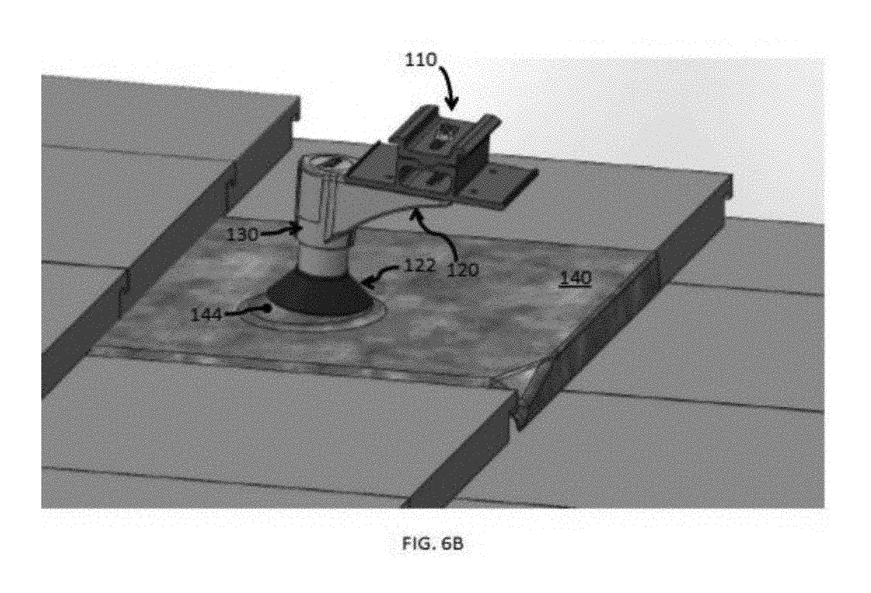

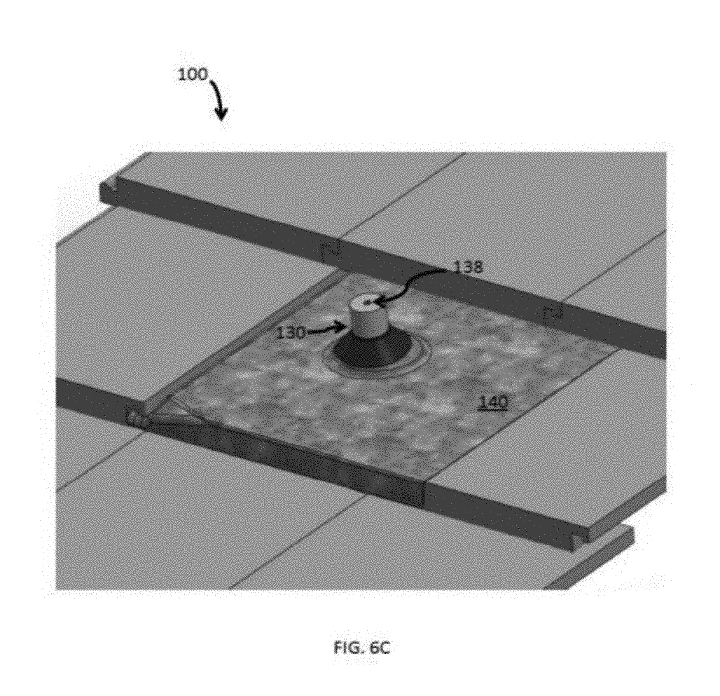

FIGS. 6A-6B illustrate a tile replacement mounting system 100 with a post 130 installed through a tile replacement flashing 140 into an attachment bracket (not shown). As shown in FIG. 6B, a rubber boot 122 can be installed over the post 130 and on to the conical protrusion 144 to seal the conical protrusion 144. Next, a support arm assembly 120 can be thread onto the threaded section 132 of the post 130 and the mounting clamp assembly 110 can be fastened to the support arm assembly 120. The length of the threaded section (not shown) allows the support arm assembly 120 and the mounting clamp assembly 110 to be vertically adjustable. Also, each of the support arm assembly 120 and the mounting clamp assembly 110 can include slots for allowing the mounting clamp assembly to be adjustable in a plane of the installation surface. When multiple support arm assemblies 120 and multiple mounting clamp assemblies 110 are installed in an array, the vertical and planar adjustability offers installers a wide degree of flexibility and misalignment correction caused by undulations in the installation surface and human error.

FIG. 6C illustrates a tile replacement mounting system 100 with a post 130 having an internal threading section 138 and installed through a tile replacement flashing 140.

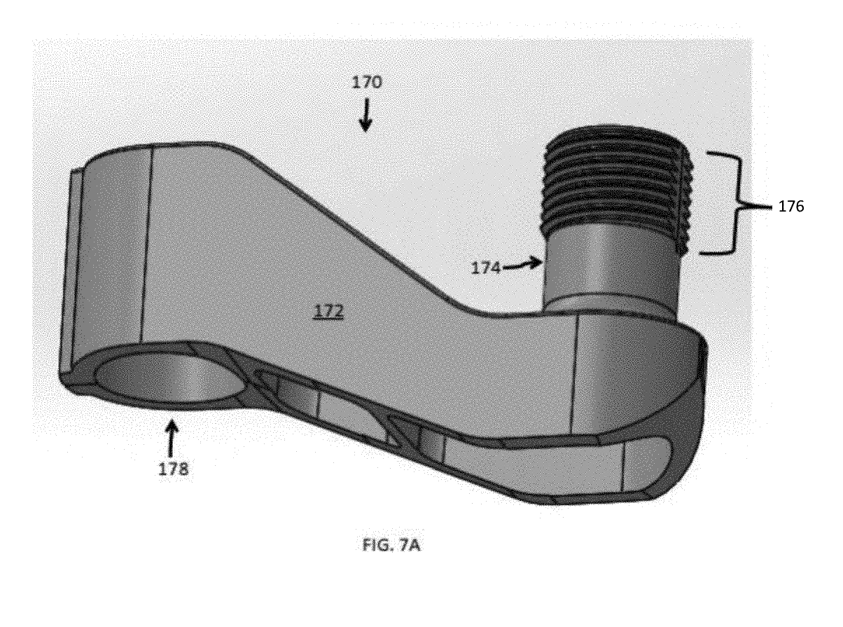

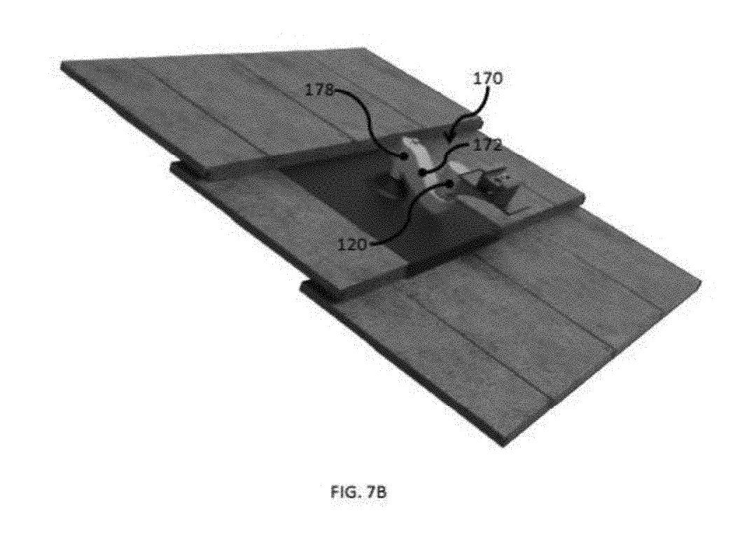

FIGS. 7A-7B illustrate an extender arm 170 that is configured to couple with the post 130 and that includes an internal section 178, a sloping extension section 172 and an extender post 174. The sloping of the sloping extension section 172 and the height of the extender post 174 can be configured to place a threaded portion 176 of the extender post 174 at substantially the same height of the threaded section 132 of the post 130 relative to the installation surface. The extender post 170 allows additional adjustability when an edge of a module (e.g. a solar PV module) does not come within the range of the support arm assembly 120. In some embodiments, the post 130 can be configured with an extended S-shape to act as the post 130/extender arm 170 combination.

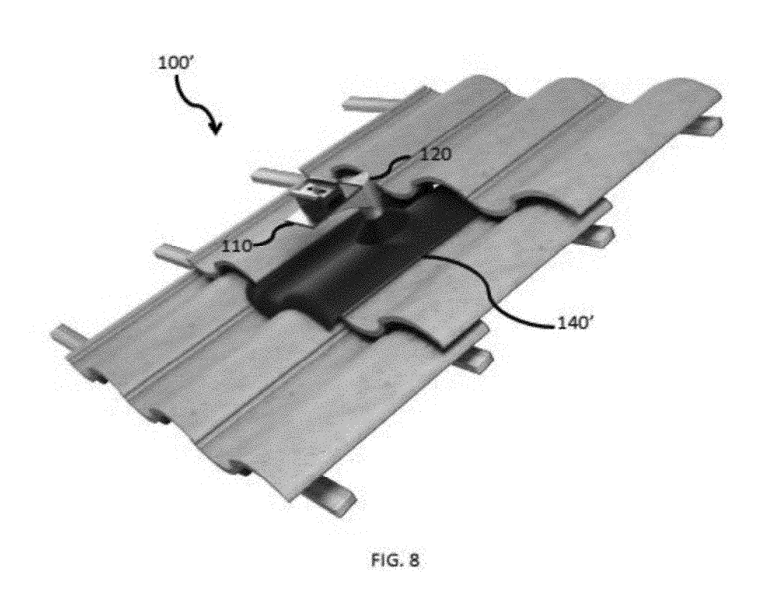

FIG. 8 illustrates a tile replacement mounting system 100′ according to some embodiments of the present technology. The tile replacement mounting system 100′ can include an S-type tile replacement flashing 140′ and universal components: a mounting clamp assembly 110, a support arm assembly 120, a post 130, a coupling mechanism (not shown), a base flashing (not shown), an attachment bracket (not shown).

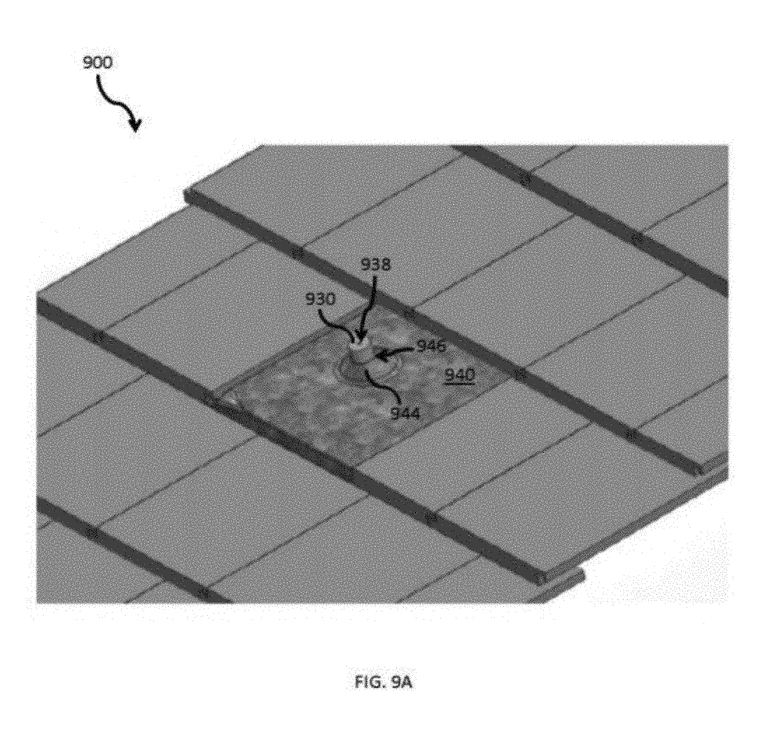

FIG. 9A illustrates a tile replacement mounting system 900 with a post 930 having an internal, threaded cavity 938 and installed through an aperture 946 in a conical protrusion 944 of a tile replacement flashing 940. In some cases, a rain collar (not shown) can be installed over the post 930 onto the conical protrusion 944 to seal the aperture 946. The internal, threaded cavity 938 of the post can be used to couple with a mounting bracket that may support any number of rooftop mounted devices, such as a solar photovoltaic panel, a solar thermal panel, air conditioning units, satellite dishes, etc. The internal, threaded cavity 938 of the post can be used to couple with an extender arm (not shown), as explained below. Additionally, the internal, threaded cavity 938 can be used to couple the post with a vertical post extender.

FIG. 9B illustrates the tile replacement mounting system 900 with a post 930 and a vertical post extender 950. The vertical post extender 950 can be substantially hollow with external threading 952 on a first end and a solid second end with a through hole (not shown). The through hole can accept a fastener for coupling the vertical post extender 950 to the internal, threaded cavity (not shown) of the post 930. The external threading 952 of the vertical post extender 950 can be used to couple with a support arm assembly (not shown) for supporting a mounting clamp assembly (not shown).

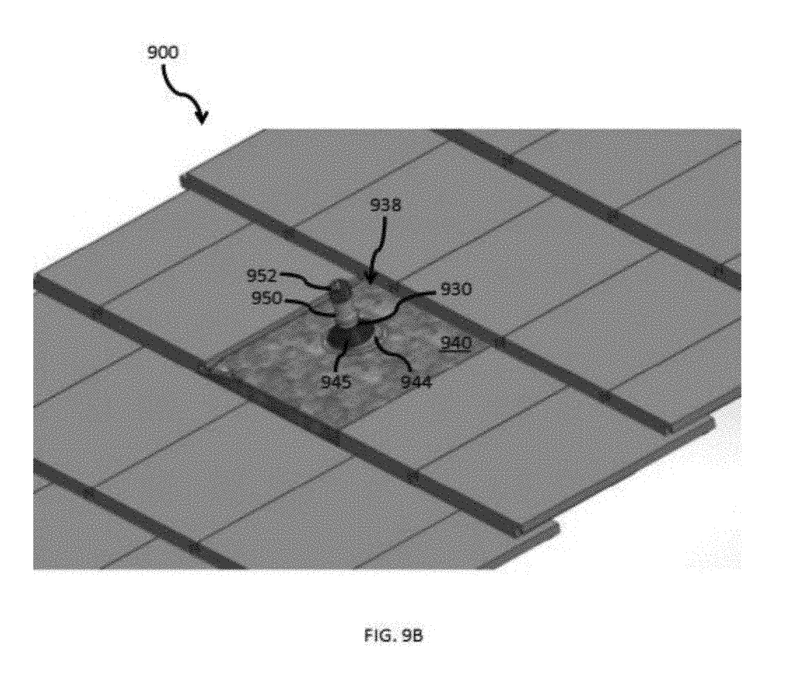

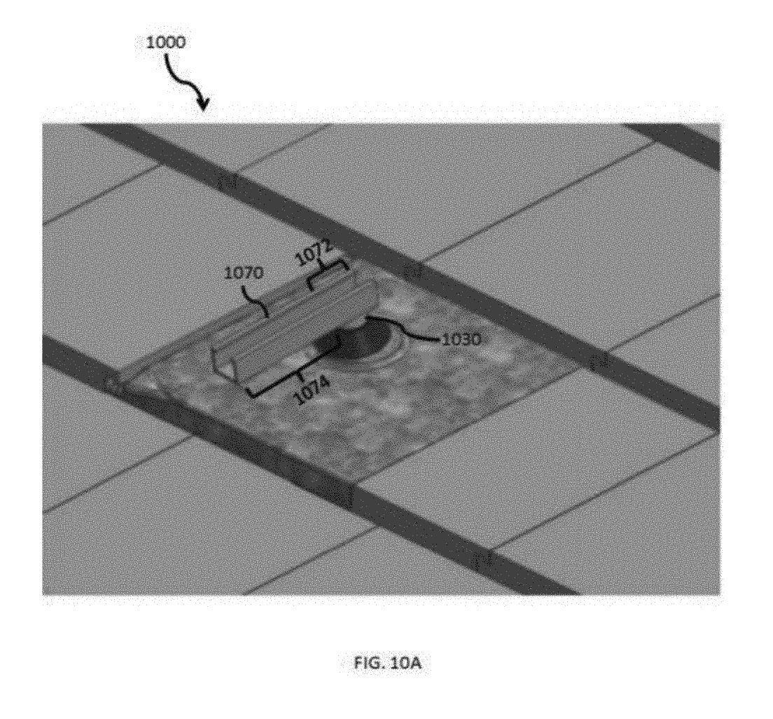

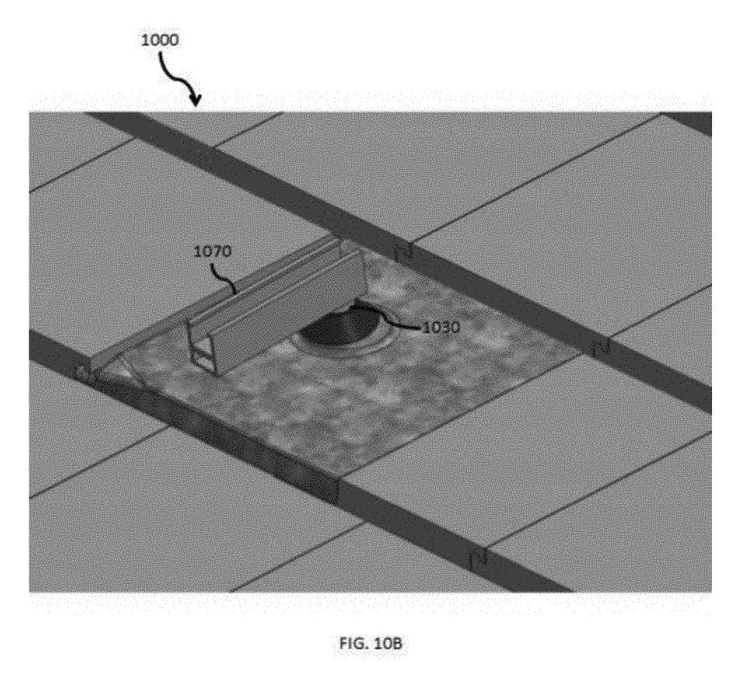

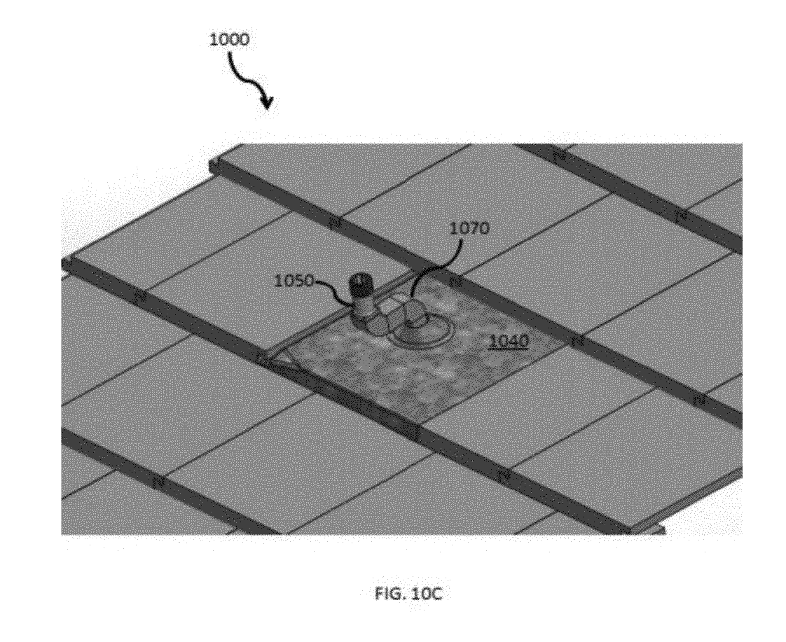

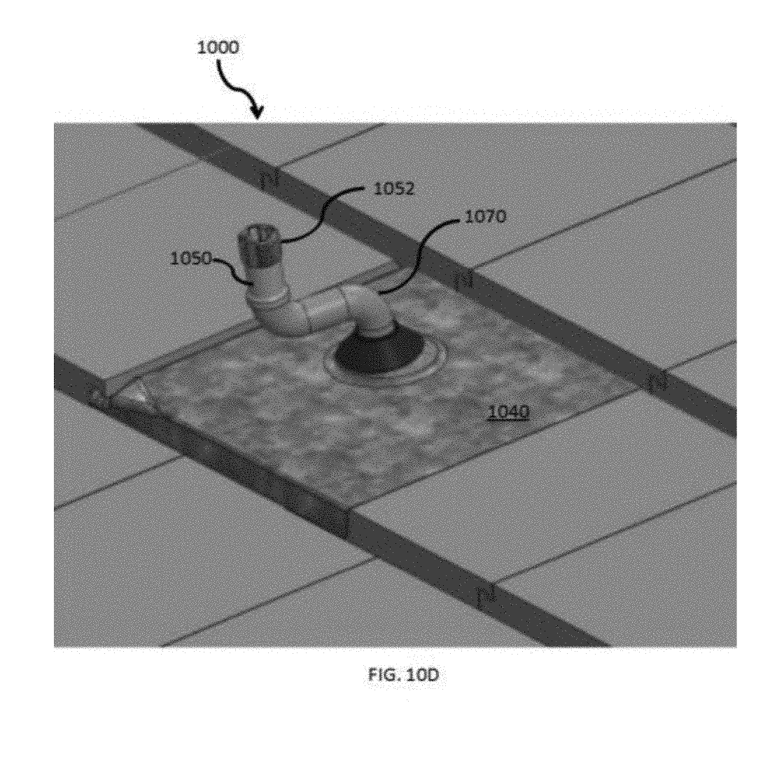

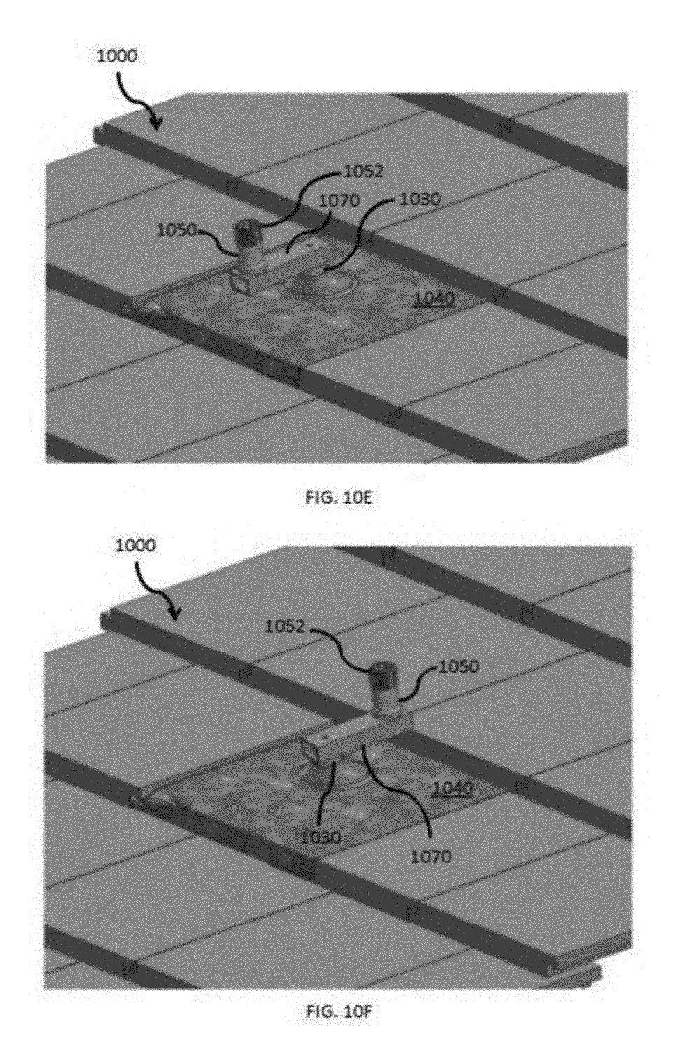

Referring again to FIG. 9A, the internal, threaded cavity 938 of the post can be used to couple with an extender arm. FIGS. 10A-10F illustrate a tile replacement mounting system 1000 with an extender arm 1070. The extender arm 1070 may include a post coupling portion 1072 and an extension portion 1074. The post coupling portion 1072 can include a hole (not shown) accepting a fastener used to couple the internal, threaded cavity of the post 1030 and extender arm 1070 through the hole.

In some cases, a tile replacement flashing is configured such that the post 1030 protrudes from the center of the tile replacement flashing. For example, a pre-fabricated tile replacement flashing with the aperture in the center of the tile replacement flashing can be beneficial to avoid requiring an installer to cut an aperture in a roof tile at the job site. However, the device being mounted on the installation surface can have a desired connection point that does not align with the post 1030. Therefore, the extender arm 1070 provides adjustability to the connection point through the extender arm 1070 being rotatable in a plane about the post 1030.

As shown in FIG. 10A, the extender arm 1070 is a U-channel shaped metal bar. U-channel can be used for supporting a variety of components including solar mounting systems, satellite dish systems, air conditioning units, solar water heater systems, etc. FIG. 10B illustrates the tile replacement mounting system 1000 with the post 1030 and the extender arm 1070 made from a U-channel shaped bar with an extra support rib, representing one example of the present invention. In some embodiments not shown, extender arm 1070 may be a square hollow tube, round hollow tube, solid bar, C-channel bar, or an aluminum extruded shape specific to the particular mounting application.

As shown in FIGS. 10C and 10D, the extender arm 1070 traverses through the aperture of a tile replacement flashing 1040 and couples directly to an attachment bracket (not shown). In some other cases, the pipe stock and the square stock can include attachment points for coupling to a post. Also, in FIGS. 10C and 10D, a vertical extender 1050 is attached to the end of the extender arm 1070. In some cases, the vertical extender 1050 can be preassembled on the extender arm 1070. FIG. 10C illustrates the tile replacement mounting system 1000 and the extender arm 1070 made from square bar. Similarly, FIG. 10D illustrates the tile replacement mounting system 1000 with the extender arm 1070 made from a round tube.

FIGS. 10E-10F illustrate a tile replacement mounting system 1000 with a post 1030, an extender arm 1070, and a vertical extender 1050. The extender arm 1070 can have a hole for attaching the extender arm 1070 with the post 1030 and an additional attachment point (e.g. a hole) for attaching with the vertical extender 1050. Further, the vertical extender 1050 may have external threading 1052 used to couple a support arm assembly (not shown) for supporting a mounting clamp assembly (not shown). The hole in the extender art 1070 can accept a fastener (not shown) to couple the extender arm 1070 with the post 1030. Before the fastener is tightened down, the extender arm 1070 can rotate in a plane parallel to the installation surface and can be locked in place by tightening the fastener. Accordingly, components (e.g. a support arm assembly for supporting a mounting clamp assembly) can be adjustable relative to the installation surface despite the tile replacement flashing having a pre-cut aperture for accepting the post 1030. FIG. 10F illustrates the tile replacement mounting system 1000 with the post 1030, the extender arm 1070, and the vertical extender 1050 rotated into a second position.

FIG. 11 illustrates a tile replacement mounting system 1100 with integrally-formed post, extender arm, and vertical extender component 1180. In some cases, a post, extender arm, and vertical extender can be formed in a single, integral extender arm 1080 (e.g. die-cast). In other embodiments not shown, the integral extender arm 1080 may be comprised of a post, extender arm, and vertical bracket. The integral extender arm 1080 may also have an integrated coupling mechanism or pre-installed coupling mechanism for attaching to a roof bracket under the tile replacement flashing.

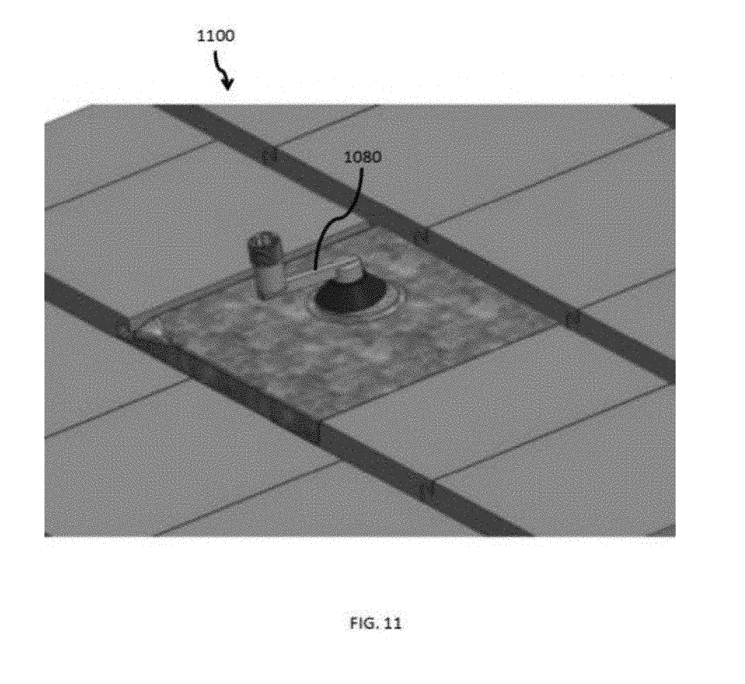

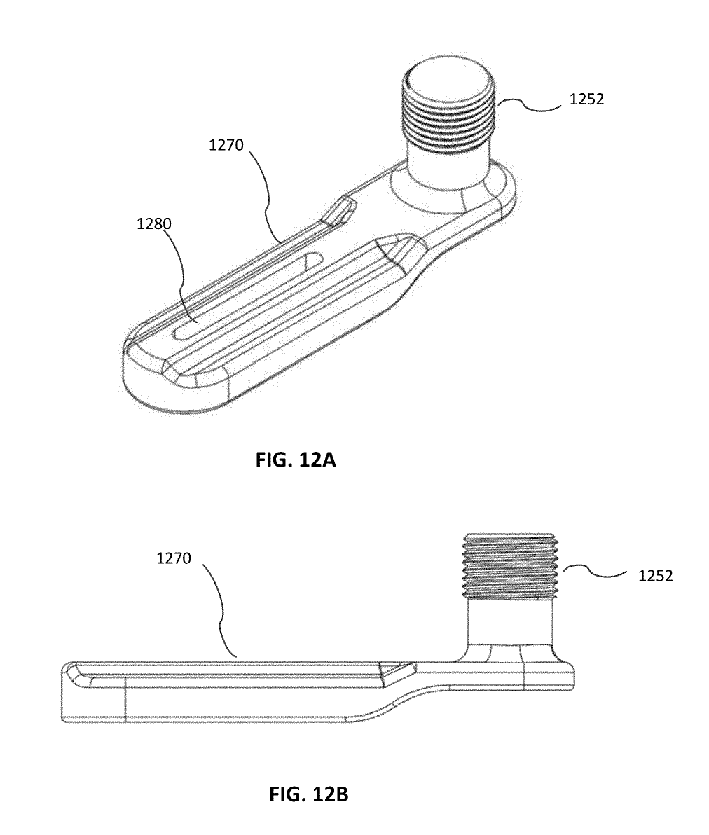

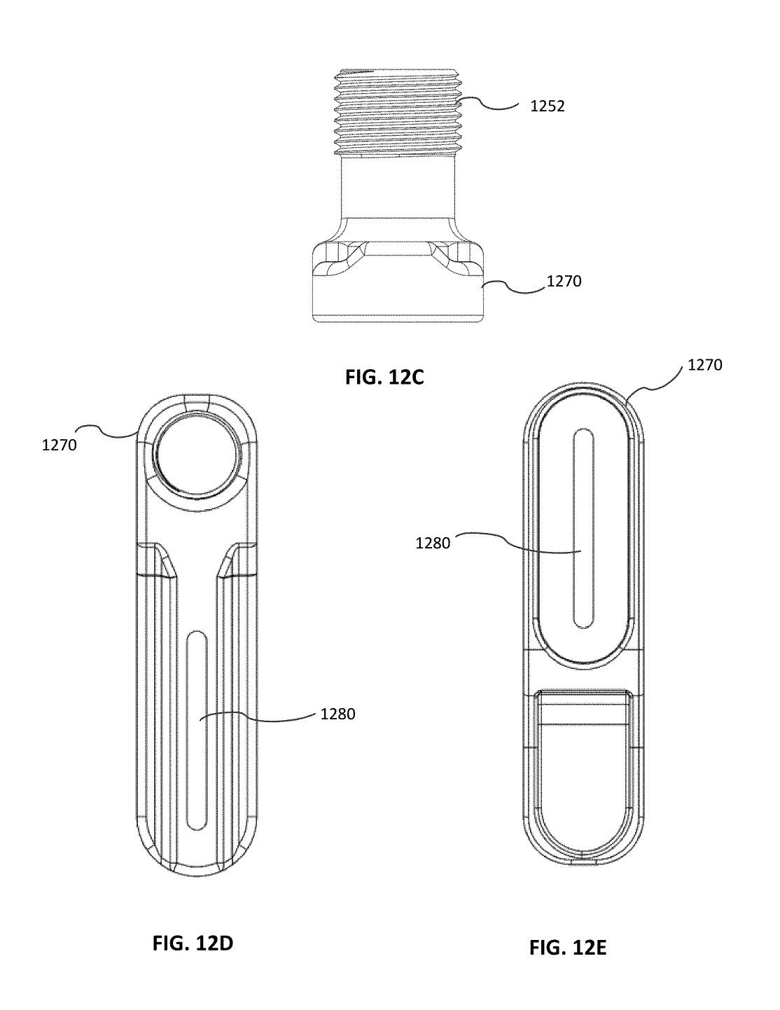

FIGS. 12A-12E illustrate extender arm 1270 that is configured to couple with post 130. The extender arm 1270 includes a threaded portion 1252, and a slot 1280. Threaded portion 1252 can be connected to mounting clamp 110. A fastener connected to internal threaded section 138 of post 130 through slot 1280 can be used to connect extender arm 1270 to post 130. FIG. 12A provides a perspective view of extender arm 1270, while FIGS. 12B, 122C, 12D, and 12E provide a respective side, end, top, and bottom view of extender arm 1270.

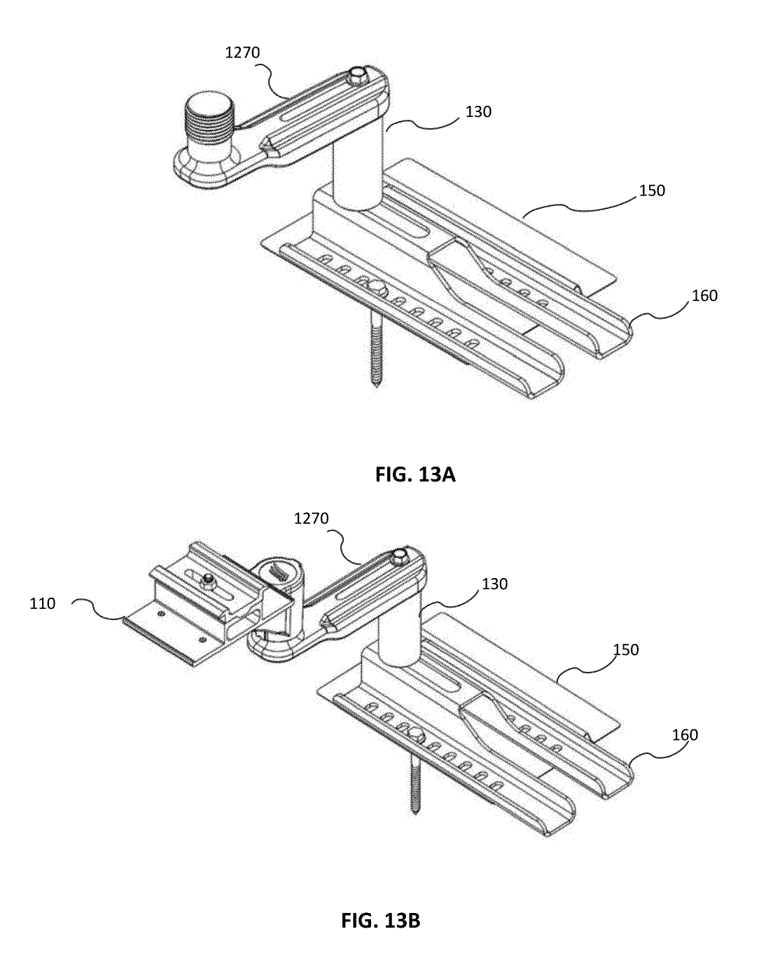

FIGS. 13A-13C illustrate extender arm 1270 connected to post 130, with post 130 connected to attachment bracket 160 and cooperating with base flashing 150. FIGS. 13B and 13C illustrate a mounting clamp assembly 110 connected to extender arm 1270, where FIG. 13C illustrates an exploded view of the various components.

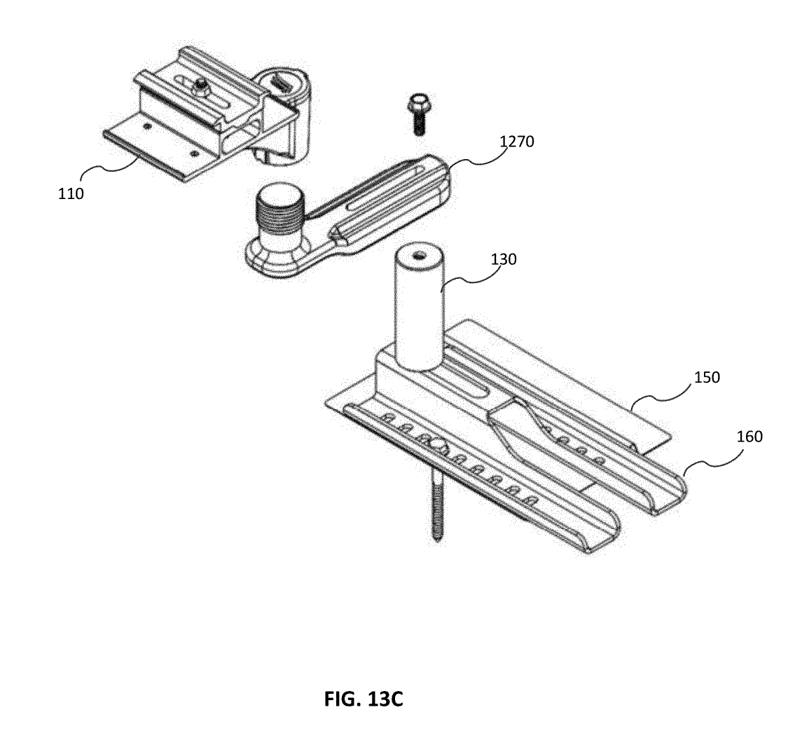

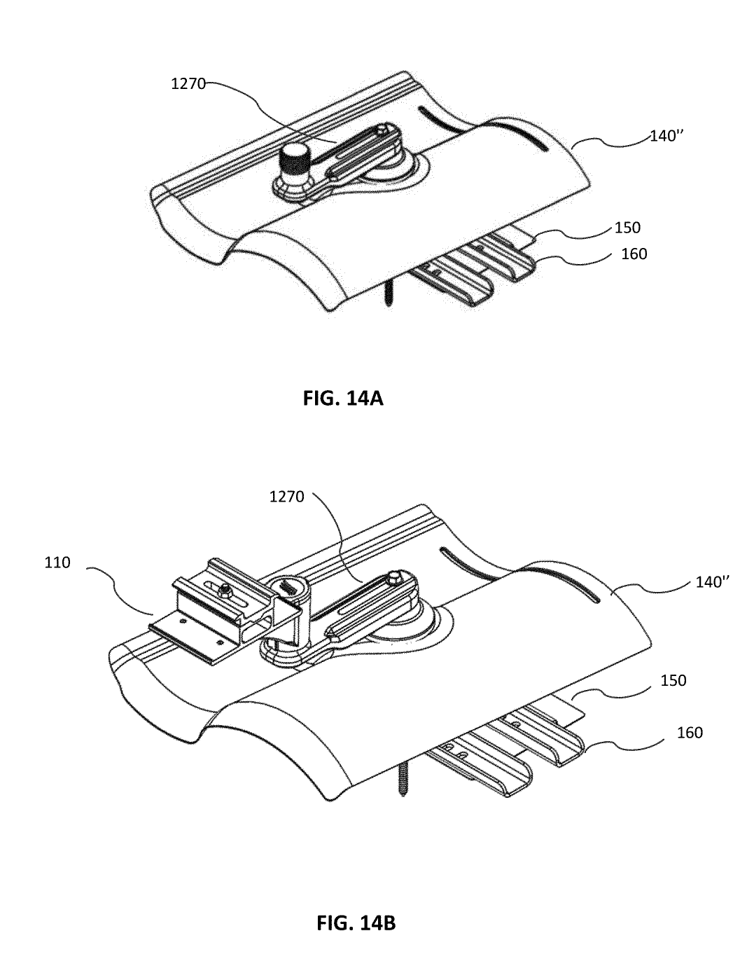

FIGS. 14A and 14B illustrate a tile replacement mounting system according to some embodiments, where the tile replacement mounting system includes an S-type tile replacement flashing 140″, and other components: a mounting clamp assembly 110, an extender arm 1270, a base flashing 150 and an attachment bracket 160.

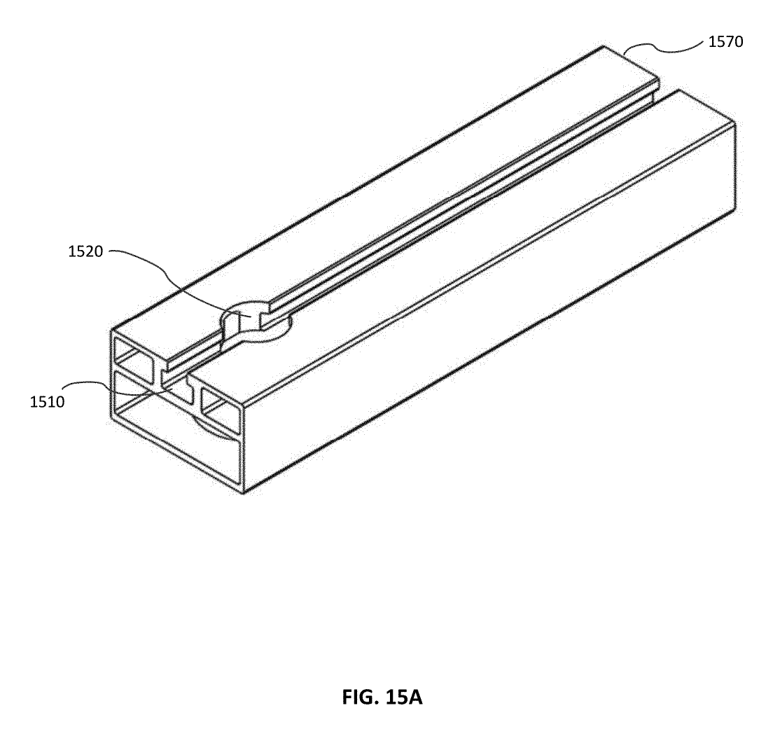

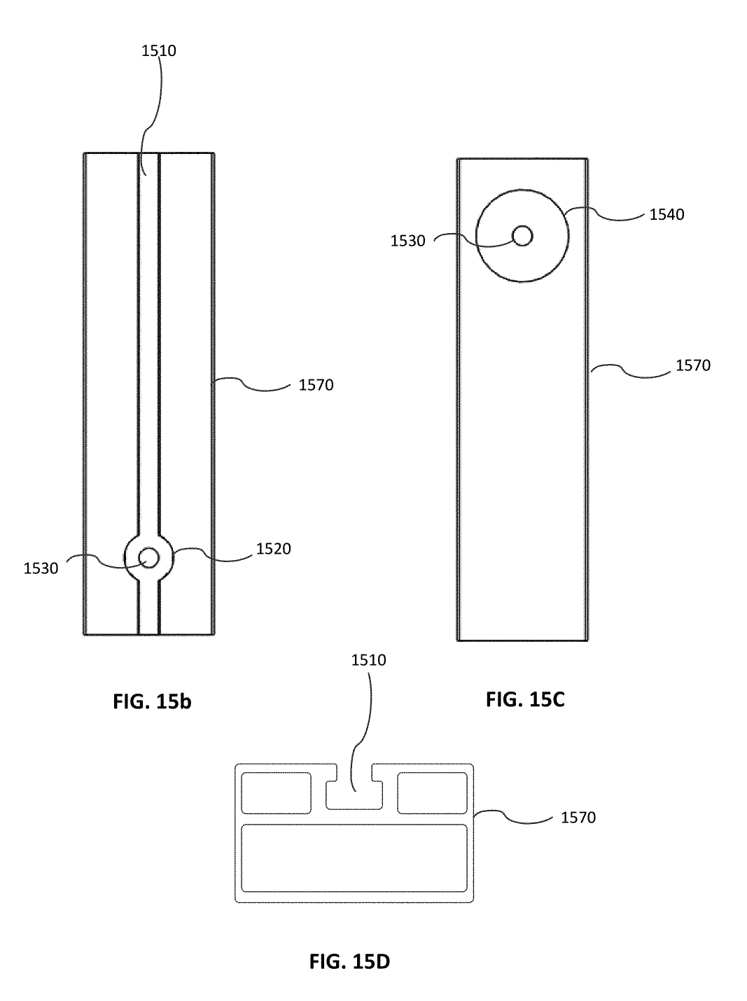

FIGS. 15A-15D illustrate an embodiment of extender arm 1570. FIG. 15 illustrates a perspective view of extender art 1570, while FIGS. 15B, 15C and 15D illustrate respective top, bottom and end views. The extender arm 1570 is re-enforced and includes a slot 1510 configured to cooperate with a fastener, and a mounting aperture (1520, 1530, 1540). The opening size of the mounting aperture is different on the respective top and bottom of extender arm 1570. On the top of extender arm 1570 the opening size of the aperture (1520) is such that a fastener head can pass through and the top of the fastener is generally flush or below the top surface of extender arm 1570. The opening size of the aperture (1530) in the middle of extender arm 1570 is smaller than the fastener head, so the fastener is constrained. The opening size of the aperture (1540) on the bottom of extender arm 1570 is large enough that post 130 can pass through. In this way a fastener connects extender arm 1570 to post 130 with the aperture (1520, 1530, 1540).

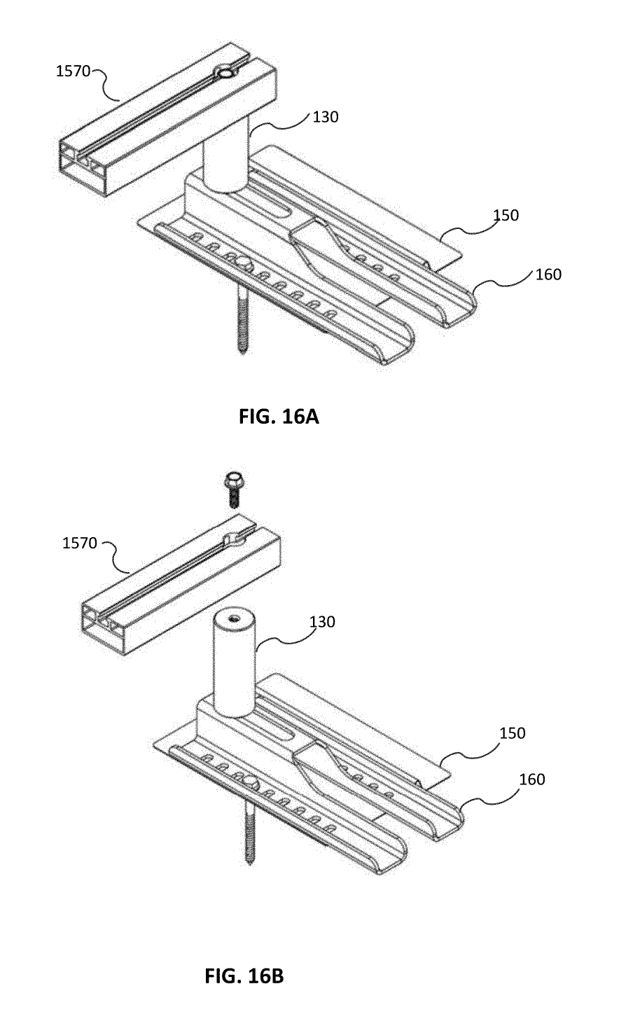

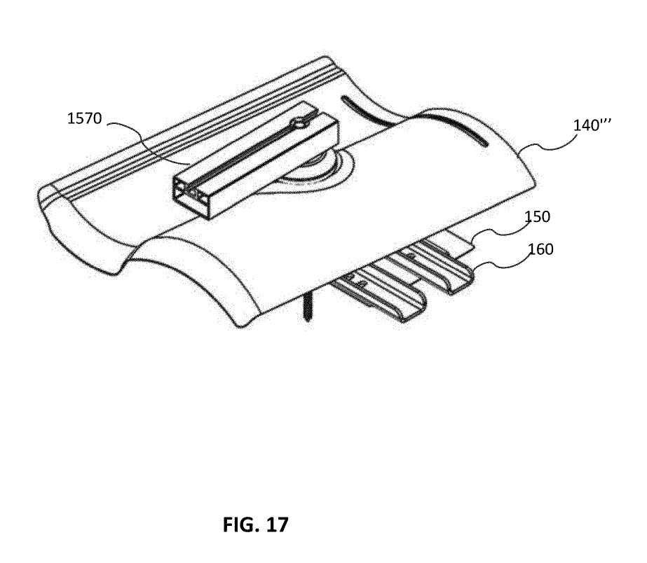

FIGS. 16A and 16B illustrate extender arm 1570 connected to post 130, with post 130 connected to attachment bracket 160 and cooperating with base flashing 150. FIG. 16B illustrates an exploded view of the various components.

FIG. 17 illustrates a tile replacement mounting system according to an embodiment where the tile replacement mounting system includes an S-type tile replacement flashing 140′″, and other components: an extender arm 1570, a base flashing 150 and an attachment bracket 160.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A solar panel mounting assembly comprising:
a tile replacement flashing configured to replace a roofing tile on an installation surface, the tile replacement flashing having an aperture disposed therethrough;
a post configured to fit through the aperture of the tile replacement flashing, the post having a first coupling mechanism on a first terminal end and a second coupling mechanism on a second terminal end; and
an extender arm wherein a first end of the extender arm attaches to the second terminal end of the post such that the extender arm extends substantially parallel with a plane of the installation surface.

2. The solar panel mounting assembly of claim 1, further comprising:
a third coupling mechanism at a second end of the extender arm.

3. The solar panel mounting assembly of claim 1, further comprising:
a vertical post extender with external threads,
wherein the vertical post extender attaches to a second end of the extender arm.

4. The solar panel mounting assembly of claim 1, wherein a second end of the extender arm curves substantially ninety degrees away from the installation surface.

5. The solar panel mounting assembly of claim 1, wherein the post and extender arm are configured as a single integral component.

6. The solar panel mounting assembly of claim 1, further comprising:
a vertical post extension,
wherein the post, the extender arm, and the vertical post extension are configured as a single integral component.

7. The solar panel mounting assembly of claim 1, wherein the first coupling mechanism comprises a T-bolt-type coupling mechanism for coupling with an attachment bracket fastened to an installation surface.

8. The solar panel mounting assembly of claim 1, wherein the first coupling mechanism comprises a cam-type coupling mechanism for coupling with an attachment bracket fastened to an installation surface.

9. The solar panel mounting assembly of claim 1, wherein the extender arm has a post-coupling portion with a hole, wherein the hole is used for accepting an additional fastener used to couple an internal, threaded cavity of the post and the extender arm through the hole.

10. The solar panel mounting assembly of claim 9, wherein the hole is an elongated slot to allow the extender arm to connect to the post at a variety of locations.

11. The solar panel mounting assembly of claim 1, further comprising:
a vertical post extender with external threading; and
a support arm coupled to the external threading of the vertical post extender.

12. The solar panel mounting assembly of claim 1, wherein the extender arm comprises square stock.

13. The solar panel mounting assembly of claim 1, wherein the extender arm comprises u-channel stock.

14. The solar panel mounting assembly of claim 1, wherein the extender arm comprises re-enforced u-channel stock.

15. The solar panel mounting assembly of claim 1, wherein the extender arm comprises round stock.

16. The solar panel mounting assembly of claim 1, wherein the extender arm comprises a channel in a top surface, the channel configured to accept a fastener head.

17. The solar panel mounting assembly of claim 1, wherein the extender arm comprises a cavity on an underside of the extender arm, the cavity configured to receive and align with the post.
